(19) United States
(12) Patent Application Publication
(10) Pub. No.: US 2024/0221976 A1
(43) Pub. Date: Jul. 4, 2024

(54) HYBRID POWER CABLE WITH MICRODUCT CONFIGURED TO RECEIVE FIBER OPTIC CABLE AT AN INSTALLATION SITE SO AS TO AVOID INSTALLATION OF UNNEEDED FIBER OPTIC CABLE

(71) Applicant: PPC BROADBAND, INC., East Syracuse, NY (US)

(72) Inventors: Jason Roland CARTWRIGHT, York, PA (US); Andrew David BAUM, York, PA (US); Curtis OLINGER, Lenexa, KS (US); Noah MONTENA, Syracuse, NY (US)

(73) Assignee: PPC BROADBAND, INC., East Syracuse, NY (US)

(21) Appl. No.: 18/399,458

(22) Filed: Dec. 28, 2023

Related U.S. Application Data
(60) Provisional application No. 63/436,292, filed on Dec. 30, 2022.

(51) Int. Cl. H01B 9/00; G02B 6/44; H01B 7/02; H01B 7/282

(52) U.S. Cl. CPC H01B 9/005; G02B 6/4432; G02B 6/44384; H01B 7/02; H01B 7/282

(57) ABSTRACT

A hybrid cable including: a jacket portion; a duct portion configured to be located inside the jacket portion; and an electrical conductor configured to be located inside the jacket portion. The electrical conductor is configured to be located outside of the duct portion; the electrical conductor and the duct portion extend substantially parallel to each other in the jacket portion; the duct portion is configured to be installed in the jacket portion in an empty state of the duct portion in which no wire or cable is in the duct portion; and the duct portion is configured to be loaded with fiber optic cable before, during, and after the hybrid cable is installed at an installation site so as to allow an installer to install an installation required number of fiber optic cables in the duct portion, thereby avoiding installation of unneeded fiber optic cable.

### CROSS-REFERENCE TO RELATED APPLICATION

This application claims the benefit of U.S. Provisional Application No. 63/436,292 filed Dec. 30, 2022, which is currently pending, the disclosure of which is hereby incorporated by reference herein in its entirety.

### BACKGROUND

The present invention relates generally to cables. More particularly, the present invention relates to a hybrid cable that includes power cables and a microduct configured to receive one or more fiber optic cables.

Hybrid cables with copper power conductors and optical fibers are currently used in wireless and similar applications to run from the ground up a tower to an antenna or other device. The optical fibers are pre-installed in the raw cable and are typically pre-terminated before installation. Due to the possibility of damage, either during installation or over time, cables with excess (spare) fibers are often used, typically twice as many as needed. If not used, these excess fibers (and connectors, if pre-terminated) add unnecessary cost to the hybrid cable. Conversely, the site at which the hybrid cable is used is limited to the number of fibers within the cable. As a result, if all the spare fibers are used and more are needed, a separate cable will need to be installed at significant cost.

It may be desirable to provide a hybrid cable that includes power cables and a microduct that is configured to receive one or more fiber optic cables either before or after installation of the hybrid cable so as to allow an installer to install an installation required number of fiber optic cables in the microduct, thereby avoiding installation of unneeded fiber optic cable.

### SUMMARY

In accordance with various embodiments of the disclosure, a microduct is configured to be loaded with fiber optic cable before, during, and after the hybrid cable is installed at an installation site so as to allow an installer to install a precise number of fiber optic cables needed at the installation site and, therefore, avoid installing unneeded fiber optic cables.

Embodiments of the disclosure include a hybrid cable having one or more empty fiber microducts assembled within the raw cable. The empty microducts provide flexibility in that they allow installers to install only the number of fiber optic cables that are needed. The microducts also allow for future repairs or capacity increases. The microducts can be partially or fully filled with fiber optic cables during the raw cable manufacturing process, or during the cable assembly process, or at the site installation. As a result, cable manufacturers, cable assemblers, and site installers are provided multiple options. Pre-terminated fibers can be used in the microducts. Embodiments include microducts having different size, type, and quantity. The other parts of the cable construction such as, for example, power conductors and fill material, can also vary.

Particular embodiments provide a hybrid cable including: a jacket portion; a moisture resistant portion, at least a portion of which may be configured to be located inside the jacket portion; a duct portion, at least a portion of which may be configured to be located inside the moisture resistant portion; and an electrical conductor, at least a portion of which may be configured to be located inside the moisture resistant portion. At least a portion of the electrical conductor may be structurally configured to be located outside of the duct portion. The electrical conductor may comprise a power conductor. The electrical conductor and the duct portion may extend substantially parallel to each other in the jacket portion. At least a portion of the duct portion may be structurally configured to be installed in the jacket portion in an empty state of the duct portion in which no wire or cable is in the duct portion. The duct portion may be structurally configured to be loaded with fiber optic cable before, during, and after the hybrid cable is installed at an installation site so as to allow an installer to install an installation required number of fiber optic cables in the duct portion, thereby avoiding installation of unneeded fiber optic cable.

According to various embodiments, the moisture resistant portion may be an inner liner.

According to various embodiments, the inner liner may comprise a strength member.

According to various embodiments, the strength member may comprise an aramid yarn.

According to various embodiments, the inner liner may comprise water blocking tape.

According to various embodiments, the moisture resistant portion may be configured to fill a space between the jacket portion and the duct portion.

According to various embodiments, the electrical conductor may have an electrically insulating coating.

According to various embodiments, the electrical conductor may comprise a first electrical conductor and the hybrid cable further comprises a second electrical conductor.

According to various embodiments, the electrical conductor may comprise a plurality of electrical conductors, and the plurality of electrical conductors may be arranged around the duct portion.

Particular embodiments provide a cable including: a jacket portion; a duct portion, at least a portion of which may be configured to be located inside the jacket portion; and an electrical conductor, at least a portion of which may be configured to be located inside the jacket portion. At least a portion of the electrical conductor may be configured to be located outside of the duct portion. The electrical conductor and the duct portion may extend substantially parallel to each other in the jacket portion. The duct portion may be structurally configured to be installed in the jacket portion in an empty state of the duct portion in which no wire or cable is in the duct portion. The duct portion may be structurally configured to be loaded with fiber optic cable before, during, and after the hybrid cable is installed at an installation site so as to allow an installer to install an installation required number of fiber optic cables in the duct portion, thereby avoiding installation of unneeded fiber optic cable.

According to various embodiments, the electrical conductor may comprise a power conductor.

According to various embodiments, the hybrid cable may further comprise a moisture resistant portion structurally configured to be located inside the jacket portion.

According to various embodiments, the moisture resistant portion may be an inner liner.

According to various embodiments, the inner liner may comprise a strength member.

According to various embodiments, the strength member may comprise an aramid yarn.

According to various embodiments, the inner liner may comprise water blocking tape.

According to various embodiments, the moisture resistant portion may be structurally configured to fill a space between the jacket portion and the duct portion.

Particular embodiments provide a hybrid cable including: a first surrounding portion; a second surrounding portion, at least a portion of which may be configured to be located inside the first surrounding portion; and an electrical conductor, at least a portion of which may be configured to be located inside the first surrounding portion and outside of the second surrounding portion. The second surrounding portion may be structurally configured to be loaded with fiber optic cable before, during, and after the hybrid cable is installed at an installation site so as to allow an installer to install an installation required number of fiber optic cables in the second surrounding portion, thereby avoiding installation of unneeded fiber optic cable.

According to various embodiments, at least a portion of the second surrounding portion may be structurally configured to be installed in the first surrounding portion in an empty state of the second surrounding portion in which no wire or cable is in the second surrounding portion.

According to various embodiments, the electrical conductor and the second surrounding portion may extend substantially parallel to each other in the first surrounding portion.

According to various embodiments, the first surrounding portion may comprise an outer jacket.

According to various embodiments, the second surrounding portion may comprise a duct.

According to various embodiments, the first surrounding portion may comprise a moisture resistant material that is configured to fill a space between the second surrounding portion and the electrical conductor.

Various aspects of the hybrid cable, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a schematic view of a wireless communication tower.

FIG. 2 is a cross-sectional view of an exemplary hybrid cable in accordance with embodiments of the disclosure.

FIG. 3 is a cross-sectional view of an exemplary hybrid cable in accordance with embodiments of the disclosure.

FIG. 4 is a cross-sectional view of an exemplary hybrid cable in accordance with embodiments of the disclosure.

FIG. 5 is a cross-sectional view of an exemplary hybrid cable in accordance with embodiments of the disclosure.

FIG. 6 is a cross-sectional view of an exemplary hybrid cable in accordance with embodiments of the disclosure.

FIG. 7 is a cross-sectional view of an exemplary hybrid cable in accordance with embodiments of the disclosure.

FIG. 8 is a cross-sectional view of an exemplary hybrid cable in accordance with embodiments of the disclosure.

FIG. 9 is a cross-sectional view of an exemplary hybrid cable in accordance with embodiments of the disclosure.

FIG. 10 is a cross-sectional view of an exemplary hybrid cable in accordance with embodiments of the disclosure.

### DETAILED DESCRIPTION OF EMBODIMENTS

Embodiments of the disclosure provide a hybrid cable that includes a duct portion that may be structurally configured to be loaded with fiber optic cable before, during, and after the hybrid cable is installed at an installation site so as to allow an installer to install an installation required number of fiber optic cables in the duct portion, thereby avoiding installation of unneeded fiber optic cable.

A hybrid cable in accordance with embodiments of the disclosure includes one or more microducts that is configured as a pathway for one or more fiber optic (or other) cables. The fiber optic (or other) cables can be run in the microduct before, during, or after installation of the hybrid cable on a wireless communication (or other) tower or other facility. The ability to install, remove, and/or replace fiber optic (or other) cables in the microduct after the microduct is installed provides a solution to the problems discussed above.

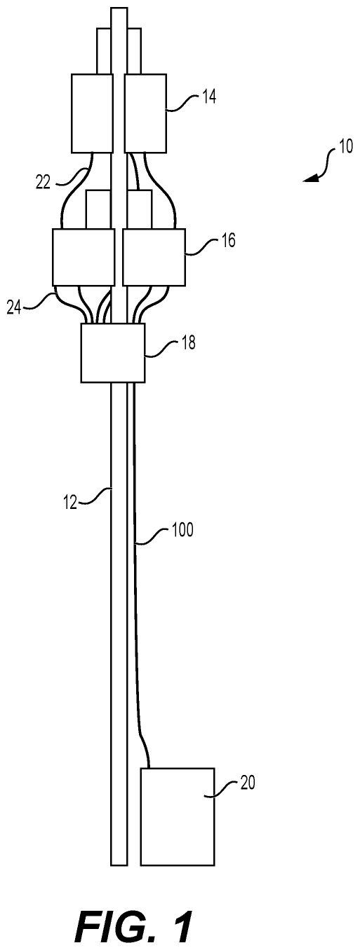

FIG. 1 shows a wireless communication installation 10 including a tower 12 to which antennas 14, radios 16, and a hybrid distribution box 18 are mounted. Abase cabinet 20 is located at a base of the tower 12. In this example, discrete 50-ohm jumpers 22 connect the radios 16 to the antennas 14, and discrete power and fiber jumpers 24 run from the hybrid distribution box 18 to the radios 16. Other configurations of the above components are also possible. A hybrid cable 100 connects the base cabinet 20 to the hybrid distribution box 18. In embodiments, the hybrid distribution box 18 contains connections between power cables and optical fiber cables in the hybrid cable 100 to various ones of the discrete power and fiber jumpers 24.

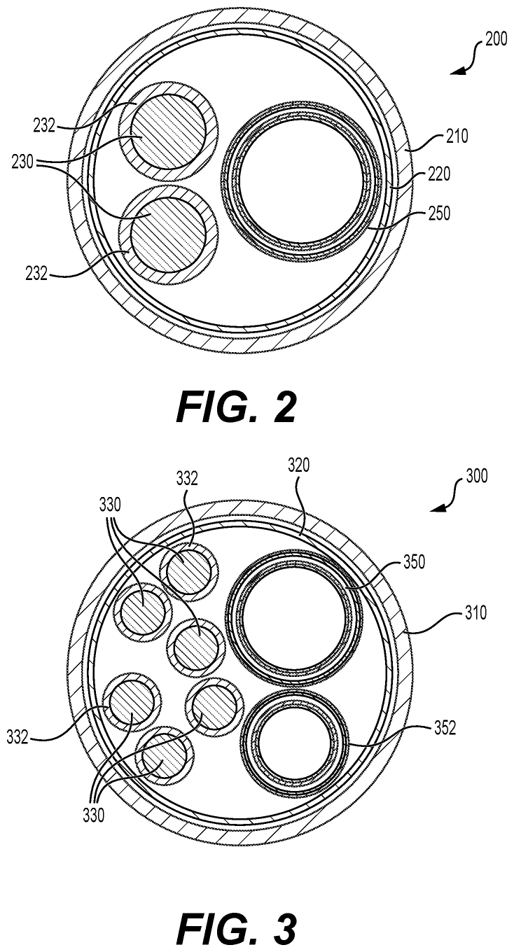

FIG. 2 shows an exemplary hybrid cable 200 in accordance with embodiments of the disclosure. In this example, hybrid cable 200 has a first surrounding portion, for example, a jacket portion, or an outer jacket, 210 and a moisture resistant portion, for example, a liner, or an inner liner, 220. In embodiments, the inner liner 220 includes one or more strength members, for example, aramid yarns and water blocking tape, or other coating or materials. The example shown in FIG. 2 includes two electrical conductors 230 having an electrically insulating coating 232. In this example, the conductors 230 are positive and negative power conductors that, for example, transmit power to the hybrid distribution box 18 and ultimately to the radios 16. A second surrounding portion, for example, a duct, or microduct, 250 is also located in the outer jacket 210. In embodiments, the conductors 230 and the microduct 250 run substantially parallel to each other in the outer jacket 210. In this example, airspace exists between the conductors 230 and the microduct 250. The microduct 250 is empty in FIG. 2 and can be empty when the hybrid cable 200 is installed on, for example, the tower 12. Fiber optic cables (or other cables) can be loaded into the microduct 250 before, during, or after the hybrid cable 200 is installed.

In some embodiments, the microduct provides a spine or backbone in the center of the hybrid cable. In some embodiments, the microduct includes radio frequency shielding if use of a copper or other conductive wire or cable is located in the microduct. All embodiments shown (and other embodiments) can be provided with or without radio frequency shielding in the outer jacket and/or the microduct. All embodiments can include a strength member. In some embodiments, the microduct acts as a strength member. The exemplary embodiments shown include a circular outer jacket. However, other embodiments include an outer jacket having a non-circular shape. For example, an outer jack can be a substantially triangular shape with two conductors and the microduct forming the three corners of the triangle.

FIG. 3 shows an exemplary hybrid cable 300 in accordance with embodiments of the disclosure. In this example, hybrid cable 300 has an outer jacket 310 and an inner liner 320. In embodiments, the inner liner 320 includes aramid yarns and water blocking tape, or other coating or materials. The example shown in FIG. 3 includes six conductors 330 having an electrically insulating coating 332. In this example, the conductors 230 are three pairs of positive and negative power conductors that, for example, transmit power to the hybrid distribution box 18 and ultimately to the radios 16. A microduct 350 and a microduct 352 are also located in the outer jacket 310. In the example shown in FIG. 3, the microducts 350, 352 are of different sizes. In one example, the smaller microduct 352 can be for containing an isolated fiber optic (or other) cable while the larger microduct 350 can be for containing a plurality of fiber optic (or other) cables. In embodiments, the conductors 330 and the microducts 350, 352 run substantially parallel to each other in the outer jacket 310. In this example, airspace exists between the conductors 330 and the microducts 350, 352. The microducts 350, 352 are empty in FIG. 3 and can be empty when the hybrid cable 300 is installed on, for example, the tower 12. Fiber optic cables (or other cables) can be loaded into one or both of the microducts 350, 352 before, during, or after the hybrid cable 300 is installed.

The microduct of embodiments allows the hybrid cable 300 to be installed on the tower, for example, before the installer knows the installation required number of fiber optic cables (the exact number of cables required by the particular installation). In embodiments, the installation required number is a number other than a standard number of optical fibers or optical fiber cables, such as, for example, 12, 24, 48, 72, 96, or 144. In embodiments, the number of the unneeded fiber optic cables is a difference between a standard number of optical fibers or optical fiber cables and the installation required number

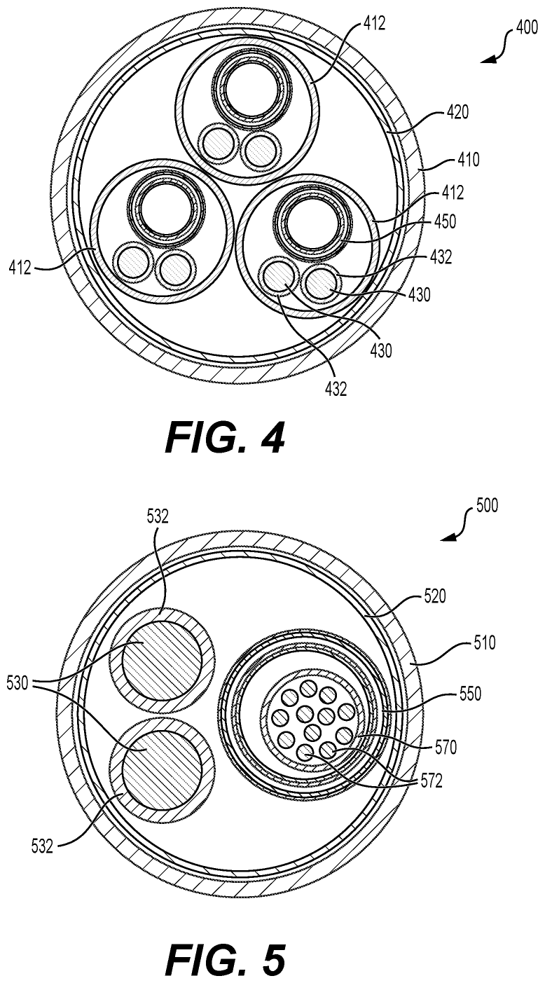

FIG. 4 shows an exemplary hybrid cable 400 in accordance with embodiments of the disclosure. In this example, hybrid cable 400 has an outer jacket 410 and an inner liner 420. In embodiments, the inner liner 420 includes aramid yarns and water blocking tape, or other coating or materials. The example shown in FIG. 4 includes three internal jackets 412. Each of the internal jackets 412 includes two conductors 430 having an electrically insulating coating 432. In this example, the conductors 230 are positive and negative power conductors that, for example, transmit power to the hybrid distribution box 18 and ultimately to the radios 16. Each of the internal jackets 412 includes a microduct 450. In the example shown in FIG. 4, the internal jackets 412 (and their components) are all the same size. In other examples, one or all of the internal jackets 412 and/or their components are of different sizes. In embodiments, the internal jackets 412 run substantially parallel to each other in the outer jacket 410. In this example, airspace exists between the conductors 430 and the microduct 450 in each of the internal jackets 412. Also, in this example, airspace exists between the internal jackets 412. The microducts 450 are empty in FIG. 4 and can be empty when the hybrid cable 400 is installed on, for example, the tower 12. Fiber optic cables (or other cables) can be loaded into one, two, or all of the microducts 450 before, during, or after the hybrid cable 400 is installed. The configuration shown in FIG. 4 can also be used to run one internal jacket 412 to each of, in this example, three radios without using the hybrid distribution box 18.

FIG. 5 shows an exemplary hybrid cable 500 in accordance with embodiments of the disclosure. In this example, hybrid cable 500 has an outer jacket 510 and an inner liner 520. In embodiments, the inner liner 520 includes aramid yarns and water blocking tape, or other coating or materials. The example shown in FIG. 5 includes two conductors 530 having an electrically insulating coating 532. In this example, the conductors 530 are positive and negative power conductors that, for example, transmit power to the hybrid distribution box 18 and ultimately to the radios 16. A microduct 550 is also located in the outer jacket 510. In embodiments, the conductors 530 and the microduct 550 run substantially parallel to each other in the outer jacket 510. In this example, airspace exists between the conductors 530 and the microduct 550. The microduct 550 is shown in FIG. 5 as containing a fiber bundle 570 that includes a plurality of individual optical fibers 572. The fiber bundle 570 can be loaded into the microduct 550 before, during, or after the hybrid cable 500 is installed.

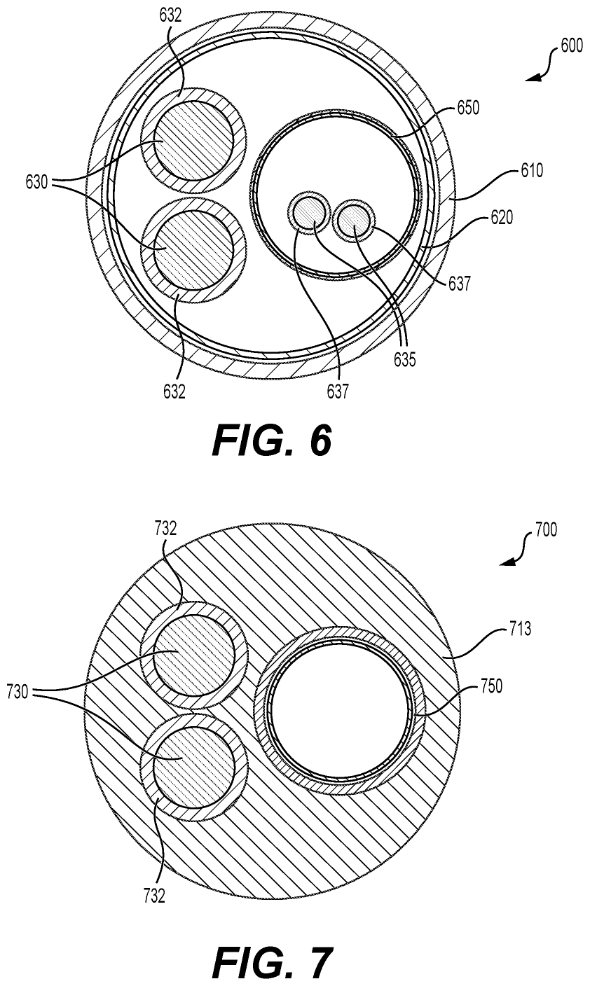

FIG. 6 shows an exemplary hybrid cable 600 in accordance with embodiments of the disclosure. In this example, hybrid cable 600 has an outer jacket 610 and an inner liner 620. In embodiments, the inner liner 620 includes aramid yarns and water blocking tape, or other coating or materials. The example shown in FIG. 6 includes two conductors 630 having an electrically insulating coating 632. In this example, the conductors 630 are positive and negative power conductors that, for example, transmit power to the hybrid distribution box 18 and ultimately to the radios 16. A microduct 650 is also located in the outer jacket 610. In embodiments, the conductors 630 and the microduct 650 run substantially parallel to each other in the outer jacket 610. In this example, airspace exists between the conductors 630 and the microduct 650. The microduct 650 is shown in FIG. 6 as containing two conductors 635 having an electrically insulating coating 632. This example illustrates that cable other than optical fiber cables can be run in the microduct 650. For example, power conductors (as shown in FIG. 6), coaxial cable, twisted pair ethernet cable, other cables, and/or other materials can be run in the microduct 650. The other cable material can be loaded into the microduct 650 before, during, or after the hybrid cable 600 is installed.

FIG. 7 shows an exemplary hybrid cable 700 in accordance with embodiments of the disclosure. In this example, hybrid cable 700 includes, instead of an outer jacket and an inner liner, a moisture resistant material 713 that completely surrounds, in this example, two conductors 730 having an electrically insulating coating 732 and a microduct 750. In this example, no airspace exists between the conductors 730 and the microduct 750 because the airspace that exists in other embodiments is filled with the material 713. The microduct 750 is empty in FIG. 7 and can be empty when the hybrid cable 700 is installed on, for example, the tower 12. Fiber optic cables (or other cables) can be loaded into the microduct 750 before, during, or after the hybrid cable 700 is installed.

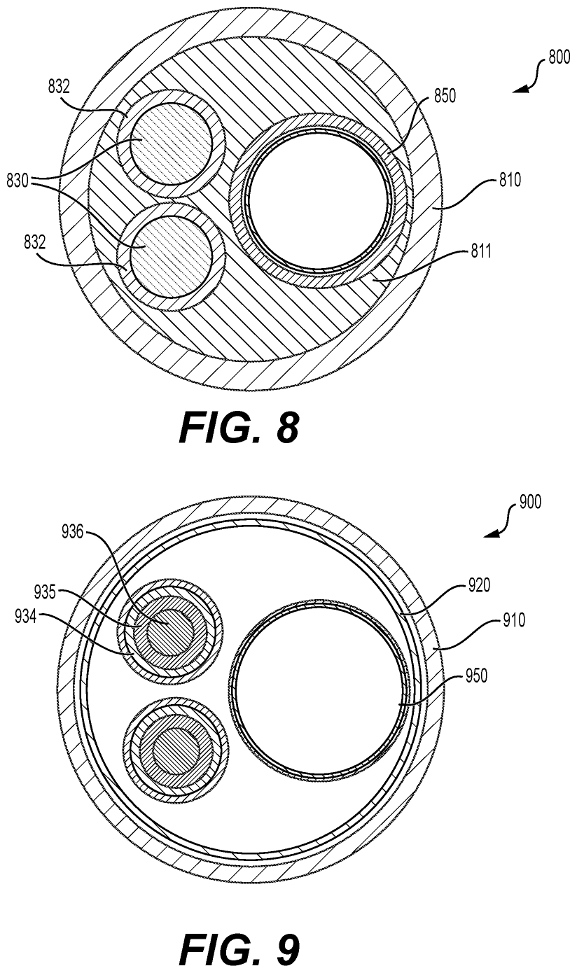

FIG. 8 shows an exemplary hybrid cable 800 in accordance with embodiments of the disclosure. The hybrid cable 800 is similar to the hybrid cable 700 in that the conductors and the microduct are held in a material, for example, a moisture resistant material, instead of being in airspace inside an outer jacket. In this example, hybrid cable 800 includes an outer jacket 810, and a material, for example, a moisture resistant material, 811 fills the outer jacket 810 and completely surrounds, in this example, two conductors 830 having an electrically insulating coating 832 and a microduct 850. In this example, no airspace exists between the conductors 830 and the microduct 850 because the airspace that exists in other embodiments is filled with the material 811. The microduct 850 is empty in FIG. 8 and can be empty when the hybrid cable 800 is installed on, for example, the tower 12. Fiber optic cables (or other cables) can be loaded into the microduct 850 before, during, or after the hybrid cable 800 is installed.

FIG. 9 shows an exemplary hybrid cable 900 in accordance with embodiments of the disclosure. In this example, hybrid cable 900 has an outer jacket 910 and an inner liner 920. In embodiments, the inner liner 920 includes aramid yarns and water blocking tape, or other coating or materials. The example shown in FIG. 9 includes two conductors (for example, low inductance power conductors) that each have an outer conductor 934 that surrounds an insulating material 935 which, in turn, surrounds an inner conductor 936. In this example, the conductors 934, 936 are positive and negative power conductors that, for example, transmit power to the hybrid distribution box 18 and ultimately to a device on the tower 12 that requires power. A microduct 950 is also located in the outer jacket 910. In embodiments, the conductors and the microduct 950 run substantially parallel to each other in the outer jacket 910. In this example, airspace exists between the conductors and the microduct 950. The microduct 950 is empty in FIG. 9 and can be empty when the hybrid cable 900 is installed on, for example, the tower 12. Fiber optic cables (or other cables) can be loaded into the microduct 950 before, during, or after the hybrid cable 900 is installed.

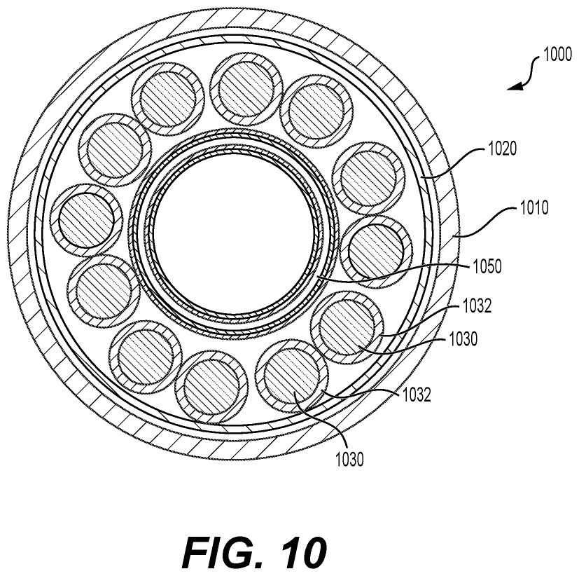

FIG. 10 shows an exemplary hybrid cable 1000 in accordance with embodiments of the disclosure. In this example, hybrid cable 1000 has an outer jacket 1010 and an inner liner 1020. In embodiments, the inner liner 1020 includes aramid yarns and water blocking tape, or other coating or materials. The example shown in FIG. 10 includes twelve conductors 1030 (six pairs of conductors) having an electrically insulating coating 1032. In this example, the conductors 1030 surround a microduct 1050 that is located at the center of the outer jacket 1010. In this example, airspace exists between the conductors 1030 and the microduct 1050. The microduct 1050 is empty in FIG. 10 and can be empty when the hybrid cable 1000 is installed on, for example, the tower 12. Fiber optic cables (or other cables) can be loaded into the microduct 1050 before, during, or after the hybrid cable 1000 is installed.

In various ones of the embodiments shown, and other embodiments, the microduct 250, 350, 450, 550, 650, 750, 850, 950, and/or 1050 has an outside diameter of 8 mm and an inside diameter of 5.5 mm. In various ones of the embodiments shown, and other embodiments, the microduct 250, 350, 450, 550, 650, 750, 850, 950, and/or 1050 has an outside diameter of 10 mm and an inside diameter of either 6 mm or 7 mm. In various ones of the embodiments shown, and other embodiments, the microduct 250, 350, 450, 550, 650, 750, 850, 950, and/or 1050 has an outside diameter not more than 25 mm.

In various ones of the embodiments shown, and other embodiments, the outer jacket 210, 310, 410, 510, 610, 810, 910, 1010 has an outside diameter of from approximately 16 mm to approximately 70 mm. For example, in one example of the hybrid cable shown in FIG. 2, the outer jacket 210 has an outer diameter of approximately 16 mm and electrical conductors 230 are 12 AWG. In another example of the hybrid cable shown in FIG. 2, the outer jacket 210 has an outer diameter of approximately 25 mm and electrical conductors 230 are 4 AWG. As another example, in one example of the hybrid cable shown in FIG. 10, the outer jacket 1010 has an outer diameter of approximately 50 mm, the microduct 1050 has an outside diameter of 10 mm, and the electrical conductors 230 are 4 AWG. In another example of the hybrid cable shown in FIG. 10, the outer jacket 210 has an outer diameter of between approximately 60 mm and approximately 70 mm, two of the microducts 1050 are used and each has an outside diameter of 10 mm, and 24 of the electrical conductors 230 are used and are 4 AWG.

In various embodiments, any or all of the items (conductors, microduct, duct, cable, etc.) in the outer jacket can be arranged parallel to each other and/or in a twisted and/or helical orientation to each other, or any combination of thereof.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A hybrid cable comprising:
a jacket portion;
a moisture resistant portion, at least a portion of which is configured to be located inside the jacket portion;
a duct portion, at least a portion of which is configured to be located inside the moisture resistant portion;
an electrical conductor, at least a portion of which is configured to be located inside the moisture resistant portion;
wherein at least a portion of the electrical conductor is configured to be located outside of the duct portion;
wherein the electrical conductor comprises a power conductor;
wherein the electrical conductor and the duct portion extend substantially parallel to each other in the jacket portion;
wherein at least a portion of the duct portion is configured to be installed in the jacket portion in an empty state of the duct portion in which no wire or cable is in the duct portion; and
wherein the duct portion is structurally configured to be loaded with fiber optic cable before, during, and after the hybrid cable is installed at an installation site so as to allow an installer to install an installation required number of fiber optic cables in the duct portion, thereby avoiding installation of unneeded fiber optic cable.

2. The hybrid cable of claim 1, wherein the moisture resistant portion is an inner liner.

3. The hybrid cable of claim 2, wherein the inner liner comprises a strength member.

4. The hybrid cable of claim 3, wherein the strength member comprises an aramid yarn.

5. The hybrid cable of claim 3, wherein the inner liner comprises water blocking tape.

6. The hybrid cable of claim 2, wherein the inner liner comprises water blocking tape.

7. The hybrid cable of claim 1, wherein the moisture resistant portion is configured to fill a space between the jacket portion and the duct portion.

8. The hybrid cable of claim 1, wherein the electrical conductor has an electrically insulating coating.

9. The hybrid cable of claim 1, wherein the electrical conductor comprises a first electrical conductor and the hybrid cable further comprises a second electrical conductor.

10. The hybrid cable of claim 1, wherein the electrical conductor comprises a plurality of electrical conductors, and the plurality of electrical conductors are arranged around the duct portion.

11. A hybrid cable comprising:
a jacket portion;
a duct portion, at least a portion of which is configured to be located inside the jacket portion;
an electrical conductor, at least a portion of which is configured to be located inside the jacket portion;
wherein at least a portion of the electrical conductor is configured to be located outside of the duct portion;
wherein the electrical conductor and the duct portion extend substantially parallel to each other in the jacket portion;
wherein the at least a portion of the duct portion is configured to be installed in the jacket portion in an empty state of the duct portion in which no wire or cable is in the duct portion; and
wherein the duct portion is structurally configured to be loaded with fiber optic cable before, during, and after the hybrid cable is installed at an installation site so as to allow an installer to install an installation required number of fiber optic cables in the duct portion, thereby avoiding installation of unneeded fiber optic cable.

12. The hybrid cable of claim 11, wherein the electrical conductor comprises a power conductor.

13. The hybrid cable of claim 11, further comprising a moisture resistant portion structurally configured to be located inside the jacket portion.

14. The hybrid cable of claim 13, wherein the moisture resistant portion is an inner liner.

15. The hybrid cable of claim 14, wherein the inner liner comprises a strength member.

16. The hybrid cable of claim 15, wherein the strength member comprises an aramid yarn.

17. The hybrid cable of claim 15, wherein the inner liner comprises water blocking tape.

18. The hybrid cable of claim 14, wherein the inner liner comprises water blocking tape.

19. The hybrid cable of claim 13, wherein the moisture resistant portion is structurally configured to fill a space between the jacket portion and the duct portion.

20. A hybrid cable comprising:
a first surrounding portion;
a second surrounding portion, at least a portion of which is configured to be located inside the first surrounding portion;
an electrical conductor, at least a portion of which is configured to be located inside the first surrounding portion and outside of the second surrounding portion; and
wherein the second surrounding portion is structurally configured to be loaded with fiber optic cable before, during, and after the hybrid cable is installed at an installation site so as to allow an installer to install an installation required number of fiber optic cables in the second surrounding portion, thereby avoiding installation of unneeded fiber optic cable.

21. The hybrid cable of claim 20, wherein at least a portion of the second surrounding portion is configured to be installed in the first surrounding portion in an empty state of the second surrounding portion in which no wire or cable is in the second surrounding portion.

22. The hybrid cable of claim 20, wherein the electrical conductor and the second surrounding portion extend substantially parallel to each other in the first surrounding portion.

23. The hybrid cable of claim 20, wherein the first surrounding portion comprises an outer jacket.

24. The hybrid cable of claim 23, wherein the second surrounding portion comprises a duct.

25. The hybrid cable of claim 20, wherein the first surrounding portion comprises a moisture resistant material that is configured to fill a space between the second surrounding portion and the electrical conductor.

26. The hybrid cable of claim 20, wherein the installation required number is a number other than 12, 24, 48, 72, 96, or 144.

27. The hybrid cable of claim 26, wherein a number of the unneeded fiber optic cables is a difference between 48 and the installation required number.
